(19) United States
(12) Patent Application Publication
(10) Pub. No.: US 2007/0019220 A1
(43) Pub. Date: Jan. 25, 2007

(54) Image forming apparatus and program

(75) Inventors: Ken Miyazaki, Sagamihara-shi (JP); Hiroyuki Arai, Tokyo (JP); Tomoo Kudo, Tokyo (JP); Hiroki Ueda, Tokyo (JP); Kenichi Ozawa, Tokyo (JP); Takemasa Ikeda, Tokyo (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: Konica Minolta Business Technologies, Inc., Tokyo (JP)

(21) Appl. No.: 11/408,258

(22) Filed: Apr. 20, 2006

(30) Foreign Application Priority Data
Jul. 22, 2005 (JP) JP2005-212565

(51) Int. Cl. G06K 15/00

(52) U.S. Cl. 358/1.12; 358/1.5

(57) ABSTRACT

An image forming apparatus, comprising: an image trailing edge position determination device which determines an image data trailing edge position in a full bleed printing mode, an image data generating device which generates image data in which a position determined by the image trailing edge position determination device is an image data trailing edge, wherein a toner image is formed and outputted on the recording medium based on the image data generated by the image data generating device, in the full bleed printing mode.

### FIELD OF THE INVENTION

The present invention relates to an image forming appratus and program provided with a full bleed printing function.

### BACKGROUND OF THE INVENTION

According to the conventional art, in an image forming apparatus based on the electrophotographic process, an image is formed based on the image data having the size greater than that of the transfer sheet, when the full bleed printing mode is used wherein printing is performed up to the very edge of a transfer sheet as a recording medium. This is intended to ensure that there is no margin on the transfer sheet. This results in the toner coming off the edge of a transfer sheet. The toner coming off the edge is removed by cleaning.

However, increase in the amount of the toner coming off the edge of the transfer sheet signifies increased waste of toner. This raises the problem of unwanted cost increase. This means an unwanted waste of the material for cleaning the transfer section such as an intermediate transfer belt and secondary transfer roller, and hence a prolonged cleaning time and reduced productivity.

One of the efforts for solving this problem is disclosed, for example, in the Patent Document 1, wherein sheet edge and skew are detected in the borderless printing mode or in the full bleed printing mode, and the image size is changed in response to the result of detection, whereby an image is formed in such a way that no margin is produced on the transfer sheet. [Patent Document 1] Official Gazette of Japanese Patent Tokkai 2004-341051

In the Patent Document 1 solves the problem wherein a margin is produced on the transfer sheet due to the misalignment in sheet conveyance by detecting the edge and skew of the sheet. However, the Patent Document 1 fails to recognize the need of reducing the amount of the toner coming off the edge. Similarly to the case of the conventional art, the Patent Document 1 increases the amount of toner to be wasted and hence the amount of the material for removing the toner coming off the edge, with the result that the problems of prolonged cleaning time and a resultant loss in costs are left unsolved.

The present inventors have found out that, when full bleed printing is performed in the image forming apparatus based on electrophotographic process, a margin is produced on the transfer sheet subsequent to image formation by the variations of the machine and expansion and contraction of the transfer sheet.

### SUMMARY OF THE INVENTION

The first object of the present invention is to reduce the amount of the toner coming off the edge of the recording medium in the full bleed printing mode and to cut down the running cost.

The second object of the present invention is to reduce the margin produced on the recording medium subsequent to image formation in the full bleed printing mode.

The third object of the present invention is to reduce the amount of toner coming off the edge of the recording medium in the full bleed printing mode and to minimize the running cost, as well as to ensure improved productivity and machine durability.

The above-mentioned problems are solved by the followings:

An image forming apparatus, comprising:
an image trailing edge position determination device which determines an image data trailing edge position in a full bleed printing mode, in which a toner image is formed and outputted based on an image data whose size is grater than that of a recording medium used for image forming through electricphotographing process on an entire area of the recording medium, based on at least one of items of information on
a positioning deviation between a leading edge position of the recording medium while recording medium conveyance, and a starting position of image forming on the recording medium,
a change of an area of the recording medium after fixing a toner image to the recording medium before fixing the toner image,
a change of a size of a toner image in a recording medium conveyance direction resulting from a fluctuations of toner image transfer speed, and
a change of a size of a toner image in the recording medium conveyance direction resulting from a fluctuation of recording medium conveyance speed; and

an image data generating device which generates image data in which a position determined by the image trailing edge position determination device is an image data trailing edge, wherein a toner image is formed and outputted on the recording medium based on the image data generated by the image data generating device, in the full bleed printing mode. An image forming apparatus, comprising:

an image trailing edge position determination device which determines a position not less than 2.6 mm and not more than 4 mm from a position corresponding to an image data trailing edge in the recording medium conveyance direction as an image data trailing edge position, in a full bleed printing mode, in which a toner image is formed and outputted based on an image data whose size is grater than that of a recording medium used for image forming through electricphotographing process on an entire area of the recording medium; and

an image data generating device which generates image data in which a position determined by the image trailing edge position determination device is an image data trailing edge,

wherein a toner image is formed and outputted on the recording medium based on the image data generated by the image data generating device, in the full bleed printing mode.

An image forming apparatus, comprising:

an image trimming device which trims an image data of trailing side, in a full bleed printing mode, in which a toner image is formed and outputted based on an image data whose size is grater than that of a recording medium used for image forming through electricphotographing process on an entire area of the recording medium,

wherein a toner image is formed and outputted on the recording medium based on the image data whose trailing edge side is trimmed by the image trimming device, in the full bleed printing.

A computer program for controlling an image forming apparatus, comprising the functions of:

a function wherein the image forming apparatus realizes to determine an image data trailing edge position in a full bleed printing mode, in which a toner image is formed and outputted based on an image data whose size is grater than that of a recording medium used for image forming through electricphotographing process on an entire area of the recording medium, based on at least one of items of information on
a positioning deviation between a leading edge position of the recording medium while recording medium conveyance, and a starting position of image forming on the recording medium,
a change of an area of the recording medium after fixing a toner image to the recording medium before fixing the toner image,
a change of a size of a toner image in a recording medium conveyance direction resulting from a fluctuations of toner image transfer speed, and
a change of a size of a toner image in the recording medium conveyance direction resulting from a fluctuation of recording medium conveyance speed, and

a function wherein the image forming apparatus realizes to generate an image data having the determined position as an image data trailing edge,
wherein a toner image is formed and outputted on the recording medium based on the image data generated in the full bleed printing mode.

A computer program for controlling an image forming apparatus, comprising the functions of:

a function wherein the image forming apparatus determines a position not less than 2.6 mm and not more than 4 mm from a position corresponding to an image data trailing edge in a recording medium conveyance direction as the image data trailing edge position, in a full bleed printing mode, in which a toner image is formed and outputted based on an image data whose size is grater than that of a recording medium used for image forming through electricphotographing process on an entire area of the recording medium;

a function wherein the image forming apparatus generates image data having the determined position as an image data trailing edge;

wherein a toner image is formed and outputted on the recording medium based on the image data generated, in the full bleed printing mode.

A computer program for controlling an image forming apparatus, comprising the functions of:

an function to trim an image data of trailing side, in a full bleed printing mode, in which a toner image is formed and outputted based on an image data whose size is grater than that of a recording medium used for image forming through electricphotographing process on an entire area of the recording medium; and

an function to form an image on the recording medium based on the image data whose trailing edge side is trimmed.

### BRIEF DESCRIPTION OF THE DRAWINGS

FIG. 1 is a block diagram representing the functional structure of the image forming apparatus 1 of an embodiment the present invention;

FIG. 2 is a diagram showing the relationship between the image data used for the full bleed printing and transfer paper arrangement area corresponding to the transfer sheet in the image data area.

FIG. 3 is a diagram showing an example of the full bleed setting screen 121;

FIG. 4 is a diagram showing an example of the. full bleed offset adjustment screen 122;

FIG. 5 is a diagram showing the structure of the major components of the printer section 105;

FIG. 6 is a diagram showing an example of storing the data of the variation parameter storage section 107a;

FIG. 7 is a diagram showing the print processing to be implemented by the CPU 101;

FIG. 8 is a flow chart showing the image trimming operation to be performed by the CPU 101;

FIG. 9 is a flow chart showing the processing of determining the position for the image trailing edge trimming to be implemented by the CPU 101;

FIG. 10 is a diagram showing the position of the image data trailing edge in the image data for full bleed printing;

FIG. 11 is an example of a screen for selecting a method of control setting of the image data trailing edge; and

FIG. 12 is an example of an input screen of the position of the image data trailing edge, which appears when “Custom” has been selected in the screen of FIG. 11.

### DESCRIPTION OF THE PREFERRED EMBODIMENT

The following describes the details of the embodiments of the present invention with reference to drawings. The structure will be described in the first place.

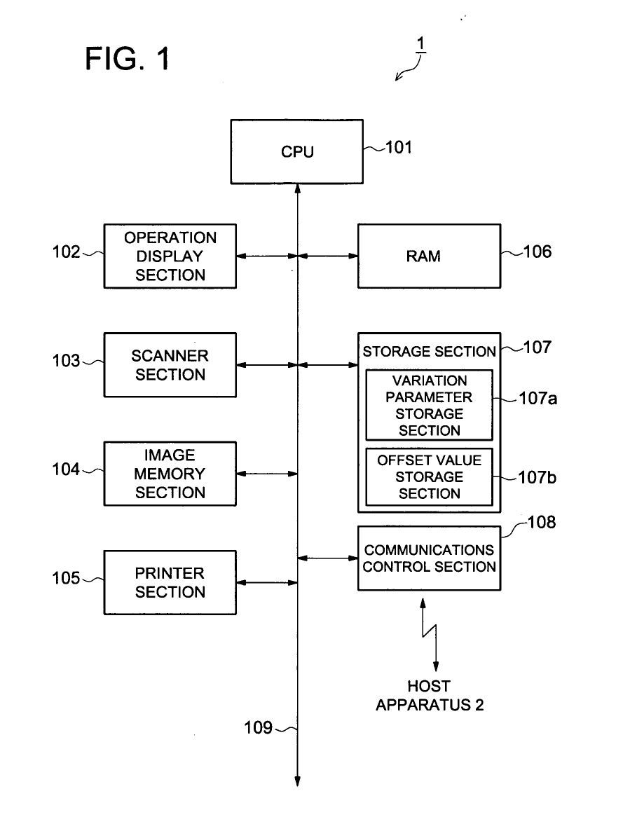

FIG. 1 shows an example of the structure inside the image forming apparatus 1 of the present embodiment. The image forming apparatus 1 is a color image forming apparatus for forming an image on the transfer sheet as a recording medium for example, according to the electrophotographic process, and outputting the same. As shown in FIG. 1, the image forming apparatus 1 includes CPU 101, operation display section 102, scanner section 103, image memory section 104, printer section 105, RAM 106, storage section 107, communications control section 108 and others. These components are connected via the bus 109.

When the operation display section 102 is operated, the CPU (Central Processing Unit) reads the system program, printing processing program, first and second image processing programs, image trimming program and various other processing programs stored in the storage section 107,and displays them on the RAM. The operations of the components of the image forming apparatus 1 are centrally controlled according to the program displayed on the RAM.

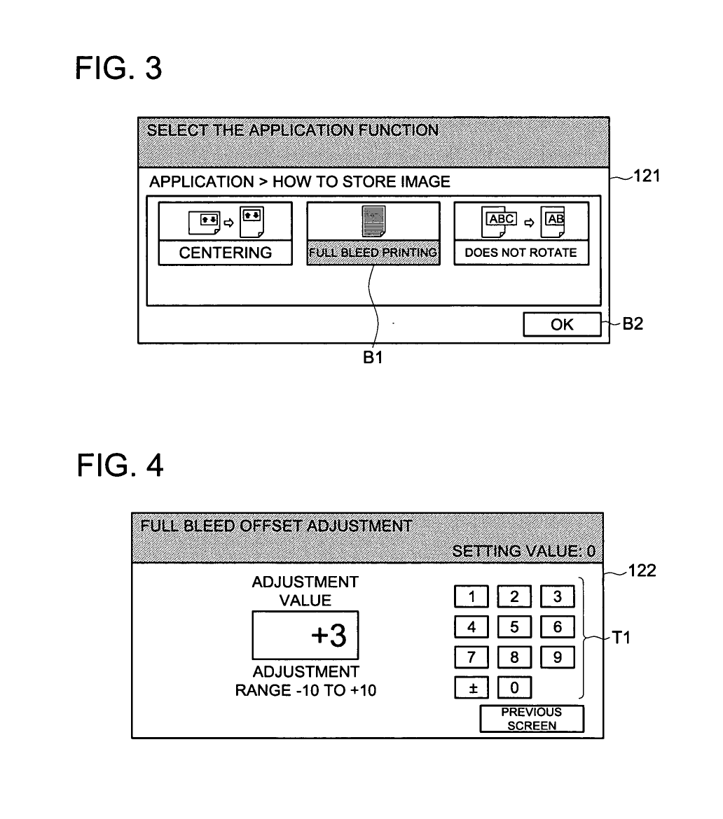

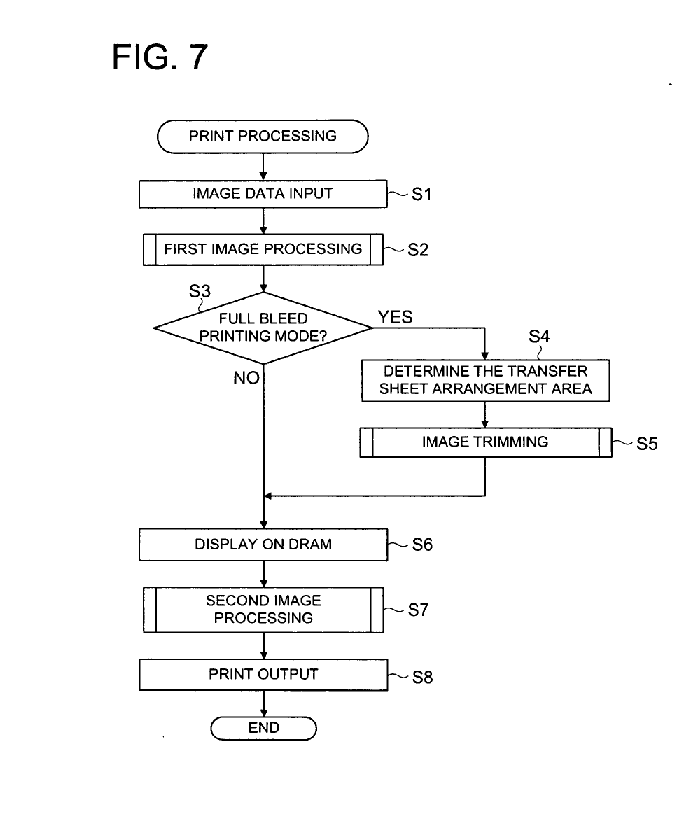

For example, when the full bleed printing mode is specified according to the input from the full bleed setting screen 121 (FIG. 3) of the operation display section 102 and the control data received from the host apparatus 2 via a communications control section 108, the CPU 101 sets the operation mode to the full bleed printing mode, and implements image trimming in the step of print processing (FIG. 7) (to be described later).

The full bleed printing mode in the sense in which it is used here refers to the mode of printing an image over the entire area of a transfer sheet. In the full bleed printing mode, to ensure that no margin is produced on a transfer sheet, an image is formed according to the image data having a size greater than that of the transfer sheet. For example, when the full bleed printing mode has been set from the host apparatus 2, a full bleed print image having a size greater than that of the transfer sheet is generated at the host apparatus 2. The image data having been generated is then sent to the image forming apparatus 1. When the image read from the scanner section 103 is printed in the full bleed mode, the transfer sheet smaller than the image having been read is conveyed, whereby full bleed printing is implemented. When a document image having the same size as the transfer sheet has been read, the read image can be enlarged to form the image for full bleed printing.

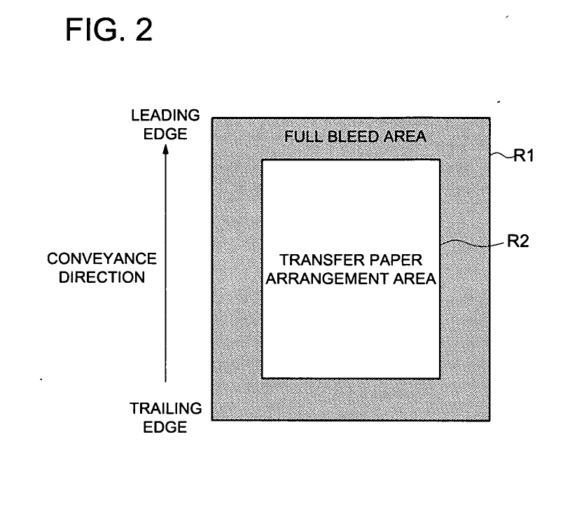

FIG. 2 shows the relationship between the image data used for full bleed printing and transfer paper arrangement area in the image data area. The area Rl in FIG. 2 is the area of the image data for full bleed printing (full bleed area). The area R2 indicates the image data area (hereinafter referred to as “transfer paper arrangement area”) corresponding to the transfer sheet used for image formation in the full bleed area. The size of the transfer paper arrangement area is the same as that of the transfer sheet used for image formation. In the full bleed printing mode, the CPU 101 controls each component of the printer section 105 for image formation in such a way that the transfer sheet will match the toner image corresponding to the transfer paper arrangement area. When an image is formed and transferred without any individual difference among machines or expansion and contraction of the transfer sheet, the size and position of the toner image corresponding to this transfer paper arrangement area match the size and position of the transfer sheet.

In the present embodiment, the transfer paper arrangement area is determined in such a way that the center of the transfer paper arrangement area will match the center of the full bleed area, without the present invention being restricted thereto. For example, the leading edge of the full bleed area can be made to match that of the transfer paper arrangement area.

The direction of the leading edge of the image data (full bleed area, transfer paper arrangement area) refers to the direction of the leading edge relative to the transfer sheet conveyance direction when a toner image is formed based on the image data in the process of image formation. The direction of the trailing edge of the image data (full bleed area, transfer paper arrangement area) refers to the direction of the trailing edge relative to the transfer sheet conveyance direction when a toner image is formed based on the image data in the process of image formation (FIG. 2). The direction of the leading edge of the transfer sheet refers to the direction of the leading edge relative to the transfer sheet conveyance direction in the process of image formation. The direction of the trailing edge of the transfer sheet refers to the direction of the trailing edge relative to the transfer sheet conveyance direction in the process of image formation.

The operation display section 102 is made up of an LCD (Liquid Crystal Display). In response to the instruction of the display signal inputted from the CPU 101, the operation display section 102 displays the full bleed setting screen 121 (FIG. 3) for the operator to set the full bleed printing mode, the full bleed offset adjustment screen 122 (FIG. 4) for inputting the full bleed offset adjustment value and many others. The LCD display screen is covered with a pressure sensitive (resistive film pressure type) touch panel formed by the transparent electrodes arranged in a grid pattern. The X-Y coordinates of the power point depressed by a finger or touch pen are detected in terms of voltage values. The position signal having been detected is outputted to the CPU 101 as an operation signal.

FIG. 3 shows an example of the full bleed setting screen 121. When the full bleed print button B1 has been selected from the full bleed setting screen 121 and the OK button B2 has been depressed, the operation mode of the image forming apparatus 1 is set to the full bleed printing mode.

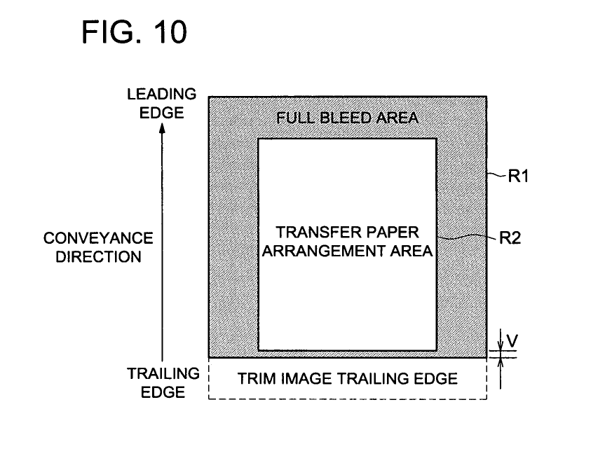

FIG. 4 shows an example of the full bleed offset adjustment screen 122 as an adjustment value setting section. The numeric key group Tl is indicated on the full bleed offset adjustment screen 122. When this numeric key group Tl has been operated and the adjustment value (offset value) has been inputted, the offset value having been inputted is stored on the offset value storage section 107b of the storage section 107. Then the image trailing edge trimming position in determining the image trailing edge trimming position (to be described later) is set. When the offset value is set to the negative side, the image trailing edge trimming position can be adjusted in the direction of the leading edge shown in FIG. 10. When the offset value is set to the positive side, the image trailing edge trimming position can be adjusted in the direction of the trailing edge shown in FIG. 10. This full bleed offset adjustment screen 122 allows the operator to adjust the image trailing edge trimming position when performing full bleed printing on a sheet of indefinite shape, or to adjust the image trailing edge trimming position with consideration given to variations in the size of the transfer sheet resulting from changes in the environment.

The scanner section 103 is provided with the scanner on the lower portion of the contact glass where a document is placed. It is used to read the image of the document. The scanner is made of the light source, CCD (Charge Coupled Device), A/D converter and others. The light applied to scan the document from the light source is reflected to form an image, after photoelectric conversion, the document image is read in the form of R, G and B signals. The image having been read is subjected to analog-to-digital conversion and is outputted to the CPU 101.

The image memory section 104 is made of a DRAM (Dynamic Random Access Memory) and others and stores the image data to be inputted, under the control by the CPU 101.

The printer section 105 forms a toner image on the transfer sheet according to the electrophotographic process, based on the image data inputted from the CPU 101, and outputs it.

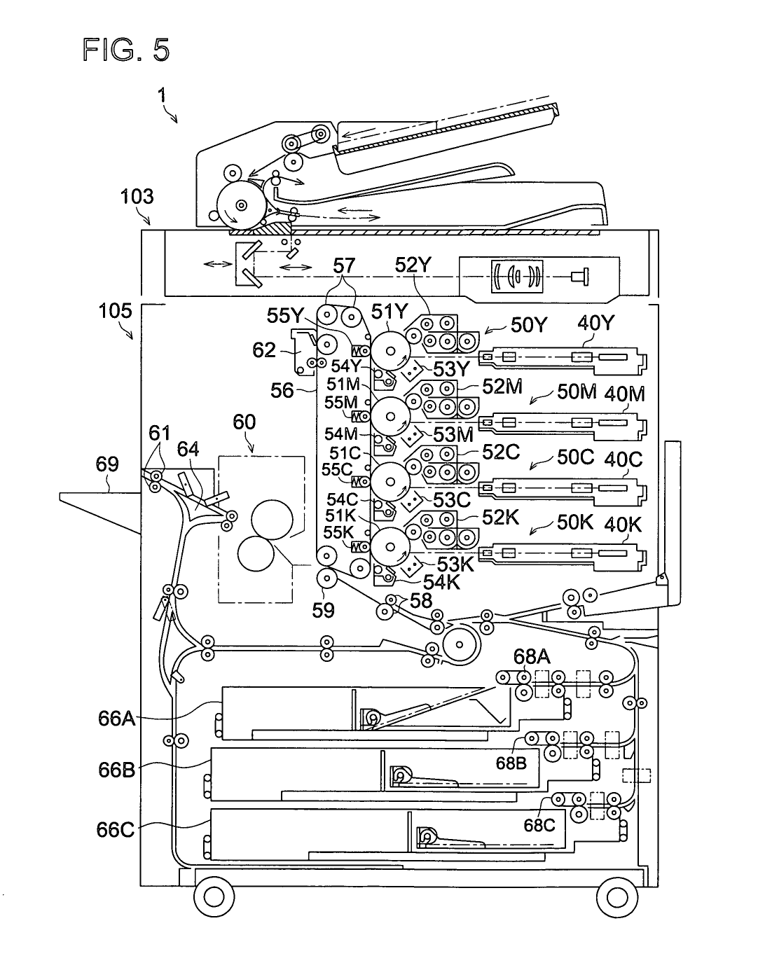

FIG. 5 shows the structure of the major components of the printer section 105. As shown in FIG. 5, the printer section 105 includes:

writing units 40Y, 40M, 40C and 40K as writing means wherein the PWM (Pulse Width Modulation) signal is generated by a pulse width modulator (not illustrated) according to the Y, M, C and K-image data having been inputted, laser light is applied to the photoreceptor drum 51Y, 51M, 51C and 51K according to this PWM signal, and the latent image is written on the photoreceptor drum;

photoreceptor units SOY, 50M, 50C and 50K for forming the Y, M, C and K toner images;

an intermediate transfer belt 56 as an intermediate transfer member for conveying the toner images formed at the photoreceptor units SOY, 50M, 50C and 50K, to the transfer sheet (rotatably by the roller 57);

a registration roller 58 for synchronizing the transfer sheet with the toner image formed on the intermediate transfer belt 56 and conveying it to the secondary transfer roller 59;

a secondary transfer roller 59 for transferring the toner image formed on the intermediate transfer belt 56, onto the transfer sheet;

a fixing unit 60 for fixing the toner image to the transfer sheet; and

a sheet ejection roller 61 for ejecting the transfer sheet.

The photoreceptor unit 50Y contains a photoreceptor drum 51Y, development device 52Y, charging device 53Y, cleaner 54Y and primary transfer roller 55Y. In the same manner, the photoreceptor units SOM, 50C and 50K also contain the corresponding devices.

The following describes the procedure of image formation in the printer section 105. In the photoreceptor unit 50Y, the photoreceptor drum 51Y rotates and the surface thereof is charged by the charging device 53Y. When the laser light source of the writing unit 40Y is applied, the latent image of the Y data is formed on the charged portion. The yellow toner image is formed on the portion of latent image by the development device 52Y. The toner image is transferred to the intermediate transfer belt 56 by the contact pressure of the primary transfer roller 55Y (primary transfer). The toner image becomes the yellow image corresponding to the image data to be outputted. The toner not having been transferred is removed by the cleaner 54Y.

The above description also applies to the photoreceptor units 50M, SOC and 50K. The magenta toner image, cyan toner image and black toner image are formed and transferred in the similar manner. The intermediate transfer belt 56 is rotated by the rotation of the roller 57, primary transfer roller 55Y, 55M, 55C and 55K and secondary transfer roller 59. The Y, M, C and K toner images are superimposed on the intermediate transfer belt 56 one after another. The transfer sheets are conveyed one by one from any one of the sheet feed trays 66A through 66C by the rotation of any one of the sheet feed rollers 68A through 68C. They are conveyed to the secondary transfer roller 59 by the rotation of the registration roller 58.

When the transfer sheet passes through the pressure section of the secondary transfer roller 59, the Y, M, C and K toner images on the intermediate transfer belt 56 are transferred onto the transfer sheet (secondary transfer). The transfer sheet on which the Y, M, C and K toner images have been transferred passes through the fixing unit 60. The Y, M, C and K toner image is fixed on the transfer sheet by the pressure and heat applied by the fixing unit 60, and color toner images are formed. The transfer sheet with an image formed thereon is conveyed to the sheet ejection tray 69 by the sheet ejection roller 61.

After formation of an image on the transfer sheet, toner is removed from the intermediate transfer belt 56 by the belt cleaning 62. Positive and negative currents are alternately applied to the secondary transfer roller 59 from the power supply 67 for a predetermined period of time. Toner deposited on the secondary transfer roller 59 is transferred to the intermediate transfer belt 56, and the secondary transfer roller 59 is cleaned.

The aforementioned components of the printer section 105 are driven under the control of the CPU 101 through various motors (not illustrated). The operation timing of these components is controlled by the CPU 101.

In various steps of processing implemented and controlled by the CPU 101, the RAM 106 provides a temporary storage area for storing the program read from the storage section 107 and the data and parameters inputted or outputted.

The storage section 107 includes a nonvolatile semiconductor memory and others. It stores the system program conforming to the image forming apparatus 1, image formation control processing program that can be implemented on the system program, the first and second image processing program, image trimming program, and various other processing programs. The programs are stored in the form of program codes readable to the computer. The CPU 101 implements operations according to the program codes. Further, the storage section 107 is provided with a variation parameter storage section 107a and offset value storage section 107b.

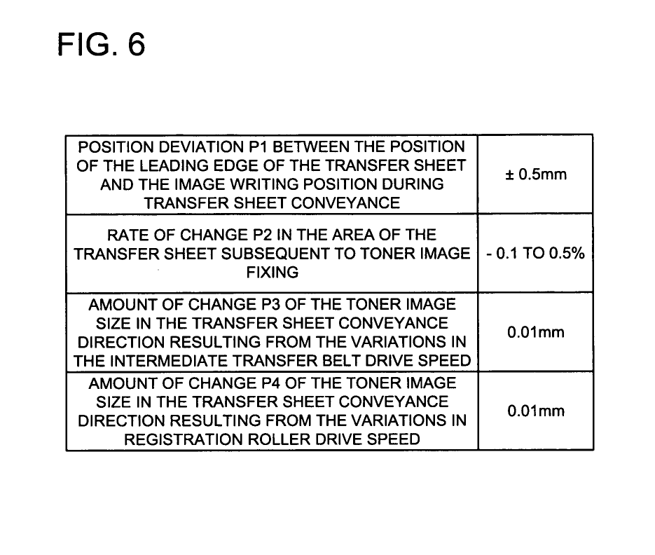

FIG. 6 shows an example of storing the data in the variation parameter storage section 107a. The variation parameter storage section 107a stores the data on variations (amounts of change) that occur to the trailing edge position of the transfer sheet subsequent to image formation. As shown in FIG. 6, the variation parameter storage section 107a stores the timing error P1 between the position of the leading edge of the transfer sheet and the image writing position during the conveyance of the transfer sheet; the rate of change P2 in the area of the transfer sheet subsequent to toner image fixing; the amount of change P3 in the toner image size in the transfer sheet conveyance direction resulting from the variations in the intermediate transfer belt drive speed; and the change P4 of the toner image size in the transfer sheet conveyance direction resulting from the variations in registration roller drive speed.

The offset value storage section 107b stores the offset value, provided on the trailing edge of the transfer paper arrangement area, having been inputted through the full bleed offset adjustment screen 122.

The aforementioned P3 is defined as the amount of change in the image size in the transfer sheet conveyance direction resulting from the variations in the toner image conveyance speed. For example, when the toner image formed on the photoreceptor drum is transferred to the transfer sheet directly without using the intermediate transfer belt, the P3 is the amount of change in the toner image size in the transfer sheet conveyance direction resulting from the variations in the drive speed of the photoreceptor drum. The P4 is defined as the amount of change in the toner image size in the transfer sheet conveyance direction resulting from the variations in the transfer sheet conveyance speed.

The communications control section 108 includes a LAN adaptor and rooter, and is used to exchange data with the host apparatus 2 and various other apparatuses via the communications line such as LAN (Local Area Network).

The host apparatus 2 is made of an input section including a keyboard, mouse and others, a communications control section for connecting the host apparatus 2 to the image forming apparatus 1, LCD and others. It is a terminal apparatus such as a PC (personal computer) equipped with an image display section, image data storage section and others. When the image data to be printed by the image forming apparatus 1 through the input section, and the printing condition settings (transfer sheet size, the number of prints, the number of printed pages, use/non-use of full bleed printing mode, use/non-use of marginal area trimming operation, etc.) have been inputted, the host apparatus 2 adds the print setting conditions to the image data as the control data. When the full bleed printing mode is designated, the image data and control data having a size greater than that of the transfer sheet used in the full bleed printing mode is sent to the image forming apparatus 1 through the communications control section.

If the image data having the size equal to or smaller than that of the transfer sheet used in the full bleed printing mode has been sent from the host apparatus 2, means can be provided to ensure that the size of the image data received by the image forming apparatus 1 will be increased to the size greater than that of the transfer sheet to be used.

The following describes the operation.

FIG. 7 shows the processing of image formation control to be implemented by the CPU 101. This processing is carried out when the operation mode and various printing condition (transfer sheet size, etc.) settings are inputted through the communications control section 108 or operation display section 102, and image formation request is inputted. It is implemented by software processing through collaboration between the CPU 101 and the image formation control processing program stored in the storage section 107. Referring to FIG. 7, the following describes the processing of image formation control.

In the first place, image data is inputted through the communications control section 108 or scanner section 103 (Step Si). When the image data has been inputted, the first image processing program is read from the storage section 107. Then conversion from brightness linear to concentration linear of the image data having been inputted, and conversion from the R, G and B image data to the C, M, Y and K image data are performed (Step S2).

This is followed by the step of determining if the operation mode is set to the full bleed printing mode or not. If it is not set to the full bleed printing mode (Step S3: No), processing goes to Step S6. If it is set to the full bleed printing mode (Step S3: Yes), the transfer paper arrangement area of the image data is determined according to the image data having been inputted, namely, the image data for full bleed printing mode and transfer sheet size (Step S4). The image trimming program is read from the storage section 107, and image trimming is performed (step S5).

In the full bleed printing mode, as described above, the image data for full bleed printing has a size greater than that of the transfer sheet. This arrangement ensures that a marginal area without image printed thereon is not present on the transfer sheet subsequent to image formation, despite variations among machines. This allows toner to come off the edge of the transfer sheet at the time of transfer. However, increase in the amount of the toner coming off the edge of the transfer sheet signifies increased waste of toner. This raises the problem of unwanted cost increase. This means an unwanted waste of the material for cleaning the transfer section such as an intermediate transfer belt and secondary transfer roller, and hence a prolonged cleaning time and reduced productivity.

To solve this problem, the image forming apparatus 1 allows the trailing edge of the image data to be trimmed at the position wherein the amount of the toner coming off the edge is minimized while full bleed printing is performed. Trimming is intended to ensure that a toner image is not formed in the process of image formation based on the data after the trimmed position. Thus, the trimming position at the trailing edge of the image data (image trailing edge trimming position) is the trailing edge of the image data. If there is no variation among the machines such as that stored in the variation parameter storage section 107a or if there is no expansion or contraction of the transfer sheet, the trimming position of the image data is the position corresponding to the trailing edge of the transfer paper in the image data area; namely, the position of the trailing edge of the aforementioned transfer paper arrangement area Actually, however, the position of the trailing edge of the transfer sheet may be misaligned with the position of the trailing edge of the transfer paper arrangement area due to the variations. To solve this problem, in the image trimming operation of the Step S5, a position is selected wherein full bleed printing can be performed despite the variations among the machines, and waste of toner and cleaning materials as well as reduction in productivity can be minimized. This position is determined as the trimming position. This trimming position is used to perform trimming operation on the image trailing edge.

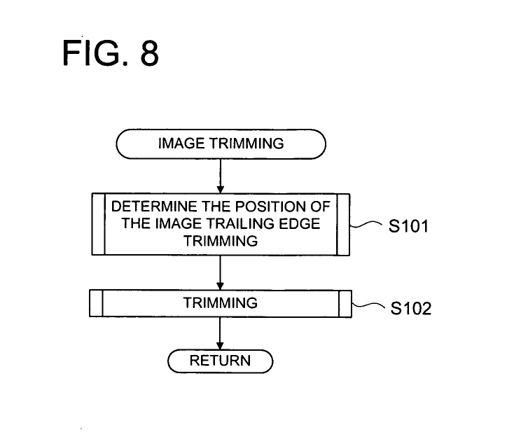

FIG. 8 shows the image trimming operation to be performed by the CPU 101 in the Step S5. The following describes the steps of image trimming in details. In the image trimming, first of all, processing of determining the position for the image leading edge trimming is implemented (Step S101). This processing ensures the image trailing edge position determining section to be implemented.

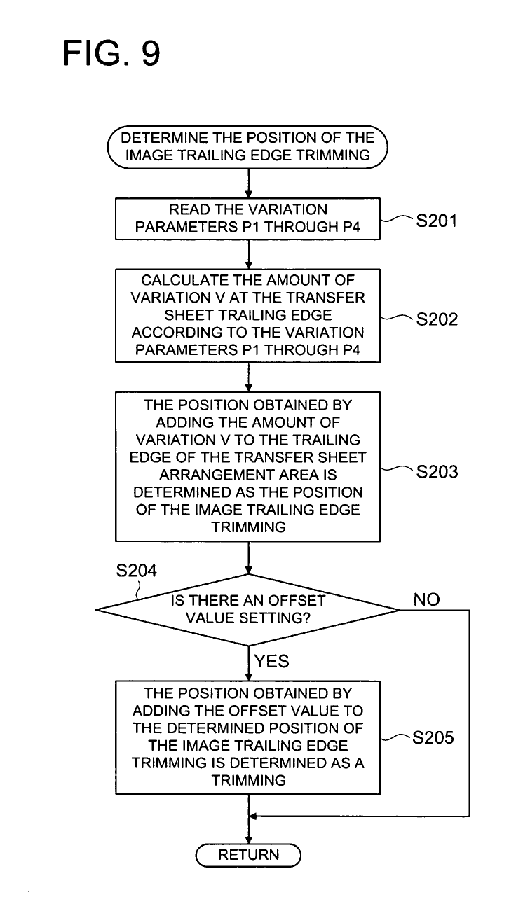

FIG. 9 shows the processing of image trailing edge trimming position determination. In the first place, the following parameters are read from the variation parameter storage section 107a (Step S201): the mis-registration P1 between the position of the leading edge of the transfer sheet and the image writing position during transfer sheet conveyance; the rate of change P2 in the area of the transfer sheet subsequent to toner image fixing; the amount of change P3 in the toner image size in the transfer sheet conveyance direction resulting from the variations in the intermediate transfer belt drive speed; and the change P4 of the toner image size in the transfer sheet conveyance direction resulting from the variations in registration roller drive speed.

Then the amount of variation V at the position of the trailing edge of the transfer sheet is calculated according to the variation parameters P1 through P4 having been read (Step S202). The amount of variation V can be obtained from the following formula where the transfer sheet size (length of the side parallel to the transfer sheet conveyance direction at the time of image formation) is assumed as SZ:
(Calculation formula) V=P1+SZ×P2/100+P3+P4

The size of the transfer sheet SZ can be that of the transfer sheet used for image formation. Further, the amount of variation V can be calculated by assuming that SZ is the maximum size of the transfer sheet that can be used in the image forming apparatus 1 (A3 in this case). According to the aforementioned calculation formula, the maximum amount of variation is 2.6 mm when the size of the transfer sheet SZ is A3 (420 mm).

When the amount of variation V has been obtained, the position obtained by adding the amount of variation V to the trailing edge of the transfer paper arrangement area is determined as the image trailing edge trimming position (Step S203). FIG. 10 schematically shows the image trailing edge trimming position. The position of the trailing edge of the transfer sheet at the time of image formation may vary within the range of the amount of variation V with reference to the trailing edge position of the transfer paper arrangement area. If an image is trimmed at the position obtained by adding the amount of variation V to the trailing edge position of the transfer paper arrangement area so that the toner image will be formed up to the position lying off the trailing edge of the transfer paper arrangement area by the amount of variation V, then full bleed printing can be performed even if the actual position of the trailing edge of the transfer sheet is off the trailing edge position of the transfer paper arrangement area by the amount of variation V. Furthermore, wasteful image formation beyond the transfer sheet trailing edge can be minimized.

When the offset value is stored in the offset value storage section 107b (Step S204: Yes), the position obtained by adding the offset value to the position determined in the Step S203 is determined as the position of the image trailing edge trimming (Step S205).

Going back to FIG. 8, when the image trailing edge trimming position has been determined, image data is trimmed at the image trailing edge trimming position having been determined (Step S102). This trimming allows the image data generation device to be implemented. Image data can be trimmed by various methods; for example, a method of trimming the image data at the image trailing edge trimming position; a method of storing the image data in the DRAM of the image memory section 104, wherein the number of lines is counted, and image storing operation stops immediately when the line equivalent to the image trailing edge trimming position from the leading edge of the image has been reached; and a method of converting the image data after the trailing edge into the data having a density (0×ff at 8-bit gradation) where toner cannot be transferred.

Upon completion of image data trimming, the system proceeds to the Step S6 of FIG. 7. The image data of the DRAM of the image memory section 104 is displayed (Step S6), and the second image processing program is read from the storage section 107. When the γ curve is applied to the image data, the output characteristics of the printer section 105 are corrected (Step S7). The image data having been subjected to image processing is output to the printer section 105. According to the image processed image data, an image is formed on the transfer sheet by the printer section (Step S8). This processing is now complete.

As described above, image forming apparatus 1 calculates the amount of variation V in the trailing edge of the transfer sheet in the full bleed printing mode, based on the mis-registration P1 between the position of the leading edge of the transfer sheet and the image writing position during transfer sheet conveyance; the rate of change P2 in the area of the transfer sheet subsequent to toner image fixing; the amount of change P3 in the toner image size in the transfer sheet conveyance direction resulting from the variations in the intermediate transfer belt drive speed; and the change P4 of the toner image size in the transfer sheet conveyance direction resulting from the variations in registration roller drive speed. A position is obtained by adding the amount of variation V to the trailing edge of the transfer paper arrangement area as the area when the transfer sheet is arranged on the image data without any amount of variation V. This position has been obtained is determined as the image trailing edge trimming position. The image data after the position having been determined is trimmed, and an image is formed on the transfer sheet based on the trimmed image data, and is then outputted.

The aforementioned arrangement ensures full bleed printing to be performed, despite the variation in the transfer sheet trailing edge position with reference to the toner image due to variations among machines or expansion and contraction of the transfer sheet. Furthermore, wasteful image formation beyond the transfer sheet trailing edge can be minimized. This arrangement reduces the amount of toner and running costs, and ensures improved productivity through the reduced cleaning time and improved machine durability through the reduced amount of cleaning materials.

The aforementioned description of the embodiment refers to a preferred example of the image forming apparatus 1 of the present embodiment, without being restricted thereto.

In the aforementioned embodiment, for example, the amount of variation V is calculated at every step of image formation. It is also possible to arrange such a configuration that the processing of the aforementioned image trailing edge trimming position determination is implemented at the time of installing or manufacturing the image forming apparatus 1, the trimming position is determined, and the trimming position having been determined is stored in the storage section 107 in advance. In this case, arrangement is made in such a way as to obtain the maximum amount of variation V, namely, the amount of variation V (2.6 mm) in A3 as the maximum size of the transfer sheet usable in the image forming apparatus 1. The position after the maximum amount of variation V (2.6 mm) from the transfer paper arrangement area is assumed as the image treatment trimming position. This arrangement ensures full bleed printing to be performed even if an image is formed independently of the size of the transfer sheet. This procedure eliminates the need of calculating the amount of variation V at every step of image formation. If the offset value has been set, the image trailing edge trimming position with allowances made for the offset value can be determined easily by adding the offset value to the preset image trailing edge trimming position at the time of image formation.

The image forming apparatus 1 ensures full bleed printing to be performed if the image is trimmed at 2.6 mm from the trailing edge of the transfer paper arrangement area. There may be slight change in the amount of variation V may according to the individual differences among image forming apparatuses and changes in the environment. When a change in the variation due to the individual difference and use of the toner and other materials are taken into account, the image trailing edge trimming position is preferably determined at 2.6 mm or more without exceeding 4 mm from the transfer paper arrangement area trailing edge as the position corresponding to the trailing edge of the transfer sheet in the conveyance direction in the image data area, according to the experiments and experience. To be more specific, the image trailing edge trimming position is preferably determined at 2.6 or more without exceeding 4 mm from the transfer paper arrangement area trailing edge leading edge. When the image trailing edge trimming position is stored in the storage section 107 in advance, it is preferably stored within the range of 2.6 mm or more without exceeding 4 mm from the transfer paper arrangement area trailing edge.

The following arrangement can also be used: The test pattern of the image data for full bleed printing is stored in the storage section 107, and a test print designation button is provided on the offset adjustment screen for designation of test printing. When the offset value has been set from this test print designation button, the test pattern stored in the storage section 107 is printed in the full bleed printing mode, and is outputted. The operator is notified that the image trailing edge trimming position should be adjusted in the negative direction if the rear of the trailing edge of the transfer sheet is contaminated with toner, and the image trailing edge trimming position should be adjusted in the positive direction if the image having been printed is not complete. This will permit easy offset adjustment.

The aforementioned description of the present embodiment refers to a preferable example of generating an image data for full bleed printing, wherein the image data trailing edge position is determined and the image data is trimmed at the determined image data trailing edge position. In addition to this method of processing, the following arrangement can also be used: Based on the instruction of full bleed printing, the image data trailing edge is determined, and image processing such as processing of scaling is applied to the image data having been inputted. Then the image data for full bleed printing is generated so that the trailing edge of the image data having been subjected to image processing will become the trailing edge of the image data having been determined.

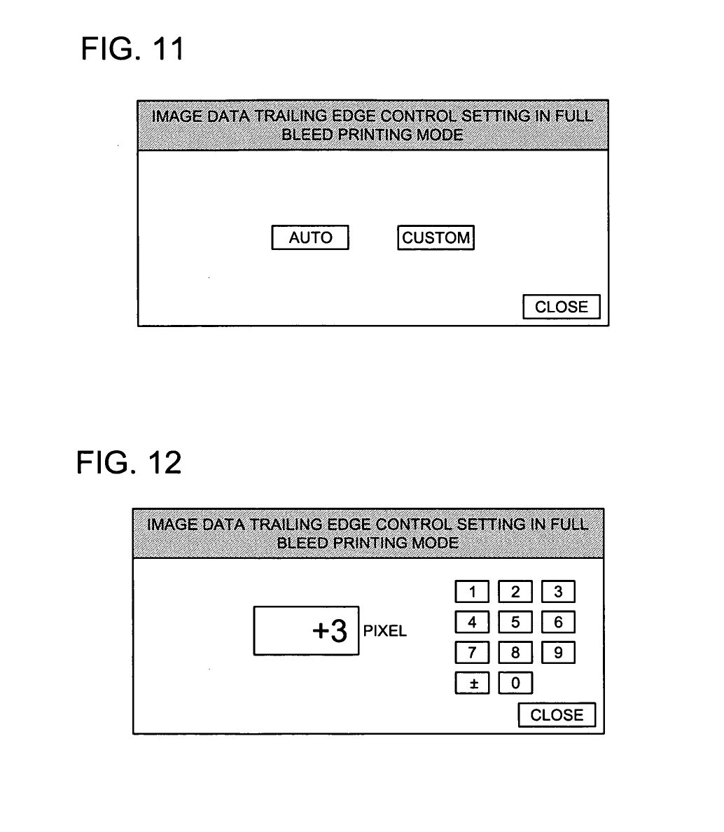

Further, the aforementioned description of the present embodiment refers to the arrangement wherein the image trailing edge position is calculated based on the variation parameter and the image trailing edge position is stored in advance. It is also possible to arrange such a configuration that a screen shown in FIG. 11 is displayed on the LCD screen. When the operator has selected “Auto”, the image trailing edge position is an image trailing edge position calculated according to the variation parameter or the preset image trailing edge position. When the operator has selected “Custom”, the input screen as an input device shown in FIG. 12 is displayed so that the image trailing edge position is inputted by the operator. If the operator has inputted the instruction indicating the number of pixels by which the image data is to be trimmed from the trailing edge in the direction of conveying the transfer sheet in FIG. 12, the position corresponding to the inputted value is determined as the image trailing edge. In FIG. 12, a millimeter (mm) or inch, instead of the number of pixels, may be used as a unit for inputting.

The aforementioned embodiment has been explained with reference to an example wherein the present invention is applied to the color image forming apparatus. The present invention can also be applied to the monochromatic image forming apparatus. The present embodiment has been described with reference to an example of the image forming apparatus wherein toner image formed on the photoreceptor drum is transferred to the transfer sheet through the intermediate transfer belt. The present invention can also be applied to the image forming apparatus wherein toner image is transferred to the transfer sheet directly from the photoreceptor drum.

Further, the detailed structure and detailed operation of various apparatuses constituting the image forming apparatus 1 can be embodied in a great number of variations with appropriate modification or additions, without departing from the technological spirit and scope of the invention claimed.

According to the aforesaid embodiment, the full breed printing is ensured even if there are occurred a fluctuation of machine and expansion and contraction of the transfer sheet such as a positioning deviation between a position of leading edge position of the recording medium while recording medium conveyance, and a starting position of image forming, a change of toner image size in the recording medium conveyance direction resulting from a fluctuation of recording medium conveyance speed, and a change of toner image size in the recording medium conveyance direction resulting from a fluctuation of recording medium conveyance speed. Also the loss resulting from the image forming exceeding the recording medium trailing edge position can be minimized. Consequently, wasting of toner is reduced and running cost can be cut. Also by shortening cleaning time, the productivity is improved and the durability of the machine is improved resulting from reducing of material consumption while cleaning.

Also full breading printing for entire area of the recording medium can be ensured and the loss resulting from the image forming exceeding the recording medium trailing edge position in the conveyance direction can be minimized. With the result that wasting of toner is reduced and running cost can be cut. Also by shortening cleaning time, the productivity is improved and the durability of the machine is improved resulting from reducing of material consumption while cleaning.

According to the aforesaid embodiment, the operator is able to adjust the image data trailing edge position.

Also by trimming image data after the image data trailing edge, image forming exceeding the recording medium trailing edge position in the conveyance direction can be reduced to minimum.

Also since image forming exceeding the recording medium trailing edge position in the conveyance direction is reduced to minimum, the consumption of wasting toner is suppressed, then by shortening cleaning time, productivity is improved and the durability of the machine is improved resulting from reducing of material consumption while cleaning.

Also, an operator can input the image data trailing position.

What is claimed is:

1. An image forming apparatus, comprising:
an image trailing edge position determination device which determines an image data trailing edge position in a full bleed printing mode, in which a toner image is formed and outputted based on an image data whose size is grater than that of a recording medium used for image forming through electricphotographing process on an entire area of the recording medium, based on at least one of items of information on
a positioning deviation between a leading edge position of the recording medium while recording medium conveyance, and a starting position of image forming on the recording medium,
a change of an area of the recording medium after fixing a toner image to the recording medium before fixing the toner image,
a change of a size of a toner image in a recording medium conveyance direction resulting from a fluctuations of toner image transfer speed, and
a change of a size of a toner image in the recording medium conveyance direction resulting from a fluctuation of recording medium conveyance speed; and
an image data generating device which generates image data in which a position determined by the image trailing edge position determination device is an image data trailing edge,
wherein a toner image is formed and outputted on the recording medium based on the image data generated by the image data generating device, in the full bleed printing mode.

2. The image forming apparatus of claim 1, wherein the change of the area of the recording medium after fixing the toner image to the recording medium before fixing the toner image, is a rate of change of the area of the recording medium.

3. The image forming apparatus of claim 1, wherein the change of the size of the toner image in the recording medium conveyance direction resulting from a fluctuation of toner image conveyance speed is an amount of change of the size of the toner image in the recording medium conveyance direction.

4. The image forming apparatus of claim 1, wherein the change of the size of the toner image in the recording medium conveyance direction resulting from a fluctuation of recording medium conveyance speed is an amount of change of the size of the toner image in the recording medium conveyance direction.

5. The image forming apparatus of claim 1, comprising:
an intermediate transfer belt,
wherein the fluctuation of toner image transfer speed is a fluctuation of rotation speed of the intermediate transfer belt.

6. The image forming apparatus of claim 1, comprising:
a registration roller,
wherein the fluctuation of recording medium conveyance speed is a fluctuation of rotation speed of the registration roller.

7. The image forming apparatus of claim 1, further comprising:
an adjusting value setting device which sets an adjusting value to the image data trailing edge position determined according to an input operation of an operator,
wherein the image trailing edge position determination device adjusts the image trailing edge position according to the adjusting value set by the adjusting value setting device.

8. The image forming apparatus of claim 1, wherein the image data generating device generates the image data having an image data trailing edge that is the position determined by trimming a data in a region after the image data trailing edged position which is determined by the image trailing edge position determination device.

9. An image forming apparatus, comprising:
an image trailing edge position determination device which determines a position not less than 2.6 mm and not more than 4 mm from a position corresponding to an image data trailing edge in the recording medium conveyance direction as an image data trailing edge position, in a full bleed printing mode, in which a toner image is formed and outputted based on an image data whose size is grater than that of a recording medium used for image forming through electricphotographing process on an entire area of the recording medium; and
an image data generating device which generates image data in which a position determined by the image trailing edge position determination device is an image data trailing edge,
wherein a toner image is formed and outputted on the recording medium based on the image data generated by the image data generating device, in the full bleed printing mode.

10. The image forming apparatus of claim 1, further comprising:
an adjusting value setting device which sets an adjusting value to the image data trailing edge position determined according to an input operation of an operator,
wherein the image trailing edge position determination device adjusts the image trailing edge position according to the adjusting value set by the adjusting value setting device.

11. The image forming apparatus of claim 1, wherein the image data generating device generates the image data having an image data trailing edge that is the position determined by trimming a data in a region after the image data trailing edged position which is determined by the image trailing edge position determination device.

12. An image forming apparatus, comprising:
an image trimming device which trims an image data of trailing side, in a full bleed printing mode, in which a toner image is formed and outputted based on an image data whose size is grater than that of a recording medium used for image forming through electricphotographing process on an entire area of the recording medium,
wherein a toner image is formed and outputted on the recording medium based on the image data whose trailing edge side is trimmed by the image trimming device, in the full bleed printing.

13. The image forming apparatus of claim 12, further comprising:
an input device which inputs the image data trailing edge position,
wherein the image trimming device trims the trailing edge side of the image data based on the trailing edge position inputted by the input device.

14. A computer program for controlling an image forming apparatus, comprising the functions of:
a function wherein the image forming apparatus realizes to determine an image data trailing edge position in a full bleed printing mode, in which a toner image is formed and outputted based on an image data whose size is grater than that of a recording medium used for image forming through electricphotographing process on an entire area of the recording medium, based on at least one of items of information on
a positioning deviation between a leading edge position of the recording medium while recording medium conveyance, and a starting position of image forming on the recording medium,
a change of an area of the recording medium after fixing a toner image to the recording medium before fixing the toner image,
a change of a size of a toner image in a recording medium conveyance direction resulting from a fluctuations of toner image transfer speed, and
a change of a size of a toner image in the recording medium conveyance direction resulting from a fluctuation of recording medium conveyance speed, and
a function wherein the image forming apparatus realizes to generate an image data having the determined position as an image data trailing edge,
wherein a toner image is formed and outputted on the recording medium based on the image data generated in the full bleed printing mode.

15. The computer program of claim 14, wherein the change of the area of the recording medium after fixing the toner image to the recording medium before fixing the toner image, is a change of rate of the area of the recording medium after fixing the toner image.

16. The computer program of claim 14, wherein the change of the size of the toner image in the recording medium conveyance direction resulting from the fluctuation of toner image conveyance speed is an amount of change of the size of the toner image in the recording medium conveyance direction resulting from the fluctuation of toner image conveyance speed.

17. The computer program of claim 14, wherein the change of the size of the toner image in the recording medium conveyance direction resulting from the fluctuation of recording medium conveyance speed is an amount of change of the size of the toner image in the recording medium conveyance direction resulting from the fluctuation of recording medium conveyance speed.

18. The computer program of claim 14, wherein the fluctuation of toner image conveyance speed is a fluctuation of rotation speed of intermediate transfer belt.

19. The computer program of claim 14, wherein the fluctuation of recording medium conveyance speed is a fluctuation of rotation speed of registration roller.

20. The computer program of claim 14, further comprising the function of:
a function wherein the image forming apparatus sets an adjusting value to the image data trailing edge position determined according to an input operation of an operator,
wherein the image trailing edge position is adjusted according to the adjusting value set.

21. The computer program of claim 14, wherein the image data having an image data trailing edge, that is the position determined by trimming a data in a region after the image data trailing edged position which is determined, are generated.

22. A computer program for controlling an image forming apparatus, comprising the functions of:
a function wherein the image forming apparatus determines a position not less than 2.6 mm and not more than 4 mm from a position corresponding to an image data trailing edge in a recording medium conveyance direction as the image data trailing edge position, in a full bleed printing mode, in which a toner image is formed and outputted based on an image data whose size is grater than that of a recording medium used for image forming through electricphotographing process on an entire area of the recording medium;
a function wherein the image forming apparatus generates image data having the determined position as an image data trailing edge;
wherein a toner image is formed and outputted on the recording medium based on the image data generated, in the full bleed printing mode.

23. The computer program of claim 22, further comprising the function of:
a function wherein the image forming apparatus sets an adjusting value to the image data trailing edge position determined according to an input operation of an operator, wherein the image trailing edge position is adjusted according to the adjusting value set.

24. The computer program of claim 22, wherein the image data having an image data trailing edge, that is the position determined by trimming a data in a region after the image data trailing edged position which is determined, are generated.

25. A computer program for controlling an image forming apparatus, comprising the functions of:
an function to trim an image data of trailing side, in a full bleed printing mode, in which a toner image is formed and outputted based on an image data whose size is grater than that of a recording medium used for image forming through electricphotographing process on an entire area of the recording medium; and
an function to form an image on the recording medium based on the image data whose trailing edge side is trimmed.

26. The computer program of claim 25, further comprising the functions of:
a function to input the data trailing edge position; and
a function to trim the trailing edge side of the image data based on the inputted trailing edge position.
